(19) United States
(12) Patent Application Publication
(10) Pub. No.: US 2014/0011574 A1
(43) Pub. Date: Jan. 9, 2014

(54) SCRIPT-BASED GAMING AND PROMOTION PLATFORM

(71) Applicant: Book Idol Inc., Montreal (CA)

(72) Inventors: Vincent SALERA, Montreal (CA); Thomas Lefebvre, Montreal (CA)

(21) Appl. No.: 13/920,961

(22) Filed: Jun. 18, 2013

Related U.S. Application Data
(60) Provisional application No. 61/661,039, filed on Jun. 18, 2012.

(51) Int. Cl. A63F 13/00

(52) U.S. Cl. CPC A63F 13/00
USPC 463/25

(57) ABSTRACT

A web-based (or cloud based) gaming platform is described which may be played in a live social gaming environment that creates an augmented reality experience for the player. The platform offers several levels, each level having a different background/view. For example, the background of the landing page (street view) may include a street view of a location near the user. The platform also features a skyline-view having as background a top view of the user's city, and a prizecloud-view having as background an image featuring. The user may use parallax scrolling to travel vertically through the different views and horizontally over other cities to explore events and promotions happening in other national/international cities.

### BACKGROUND

(a) Field

The subject matter disclosed generally relates to a web-based social gaming platform.

(b) Related Prior Art

With the evolution of electronic games and web-based media people in general and especially the young generation are losing their interest in reading.

Therefore, there is a need in the market for a system and method which integrates literature in a web-based gaming platform to encourage users to read and vote on literatures and allow writers to channel and publish their literatures and eventually compete with each other to obtain rewards.

### SUMMARY

In one aspect, there is provided a computer-readable storage device with computer executable instructions stored thereon which, when executed by a processor implement a script based gaming platform for access by one or more users over a communication network (cloud/web), the platform comprising: a user interface implemented in a web browser and accessible through the communication network; a virtual environment for accessing and voting on scripts, the virtual environment comprising different pages representing different real views taken from different altitudes, the pages comprising:
a street view page having as background a first image of a real location that is near the geographical location of the user, the street-view page featuring book related events and promotions happening in the user's neighborhood/area;

a skyline-view page having as background a second image featuring a top view of the user's city, the skyline-view page featuring book related events and promotions happening in the user's city; and

a prizecloud-view page having as background a third image featuring clouds, the prizecloud view page featuring book related events and promotions happening on a national/international level, and allowing the user to vote on scripts from national and international contestants.

The user may use parallax scrolling to travel vertically through the different pages and horizontally over other cities to explore events and promotions happening in other national/international cities and engage in gamified actions.

In an embodiment, one or more of the first image, second image, and third image are imported from an external website and selected based upon the user's IP address.

In another embodiment, users are grouped based on their IP addresses.

In a further embodiment, users in the same neighborhood may view the same street-view page.

In yet another embodiment, users in the same city may view the same skyline-view page.

It is also possible that all users may view the same prizecloud view page.

Below is a definition of some of the terms used in the present document:

Book Idol: a script-based gaming platform in accordance with the present embodiments.

Scipt: outline of a book, movie, scripture, or any story or literature based document;

Heroes of Literacy: People and organizations who supports literacy by donating, participating, and encouraging readers and writers who are members of the platform. Heroes of literacy may be nominated through social curation process and grouped according to genre and transmedia product categories. In an embodiment, a heroes wall is provided which includes a branded functional module that showcases Heroes of Literacy brand names and logos that are geo-located near the user, and provides directional indications typically found at the streetview and skyline-view altitudes of the game.

Branded Functional Module: any discreet “floating” module in the gaming environment that showcases a sponsor's brand value or function, either as a micro-game or a larger feature of the gaming environment such as prize channels, the showcase page, heroes wall, airplane or delivery truck fly-through, orange couch at drop-in.

Prize channels: Book Idol's genre-specific contest categories. For example, fiction, romance.

Contest levels: Transmedia product types including the different phases of evolution of a book e.g. a print book, an e-book, audio-book, app, video game, animation, TV show, movie, Merchandising, as shown in FIG. 4. etc.

Drop in: the action of dropping from a sponsor, contestant or fan's showcase page in cloud-view or skyline-view down to their streetview location in order to either take advantage of a time sensitive offer, or register/attend a special event.

Showcase page: profile page provided as a dashboard and fan/sponsor/advertiser utility that groups together all key registration details for contestants, sample works, purchase ready e-book, e-commerce capabilities, literacy endorsement functionality, charity of choice feature capabilities, product and service promotional capabilities (which defines affiliate relationship), voting, rating, ranking, favorites, wish list, the ability to raise money for their favorite charity, locate and drop in, photo gallery, video, audio, merchandise, directory with drop in functionality, social-media links and integration.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an example of a street view, in accordance with an embodiment;

FIG. 2 illustrates an example of a skyline view in accordance with an embodiment;

FIG. 3 illustrates an example of a prizecloud view in accordance with an embodiment;

FIG. 4 illustrates an example of a list of transmedia product types that the literature may evolve to throughout the gaming process;

FIG. 5 illustrates an exemplary distribution of access pages based on the geo-location of the users, in accordance with a non-limiting implementation of the present embodiments;

FIG. 6 illustrates an example of a showcase page; and

FIG. 7 illustrates an example of the heroe's wall.

It will be noted that throughout the appended drawings, like features are identified by like reference numerals.

### DETAILED DESCRIPTION

In an embodiment, a web-based (or cloud based) gaming platform is provided which is otherwise known as “Book Idol”. Book Idol's mission is to leverage its contest platform to discover, curate, package and monetize the next blockbuster franchise stories through the social-gamification of publishing industry-related sponsor benefits, and the licensing of winning stories into multiple product categories and complementary formats (from print book to e-book to audio book to graphic novel to App to game to TV show to Movie to merchandise) through Book Idol's transmedia packaging partners in a global publishing marketplace.

In an embodiment, Book Idol is played in a live social gaming environment that creates an augmented reality experience for the player using Google Maps API (as an example of web-based maps that may be used) and geo-locates players (whether contestants, fans, sponsor or advertisers) based on their IP addresses. In an embodiment, users are grouped based on their geolocation as determined from their IP address, whereby the user's IP address determines the default landing position and situates the player, whether contestant or fan, in a virtual environment (which may be a 3D environment).

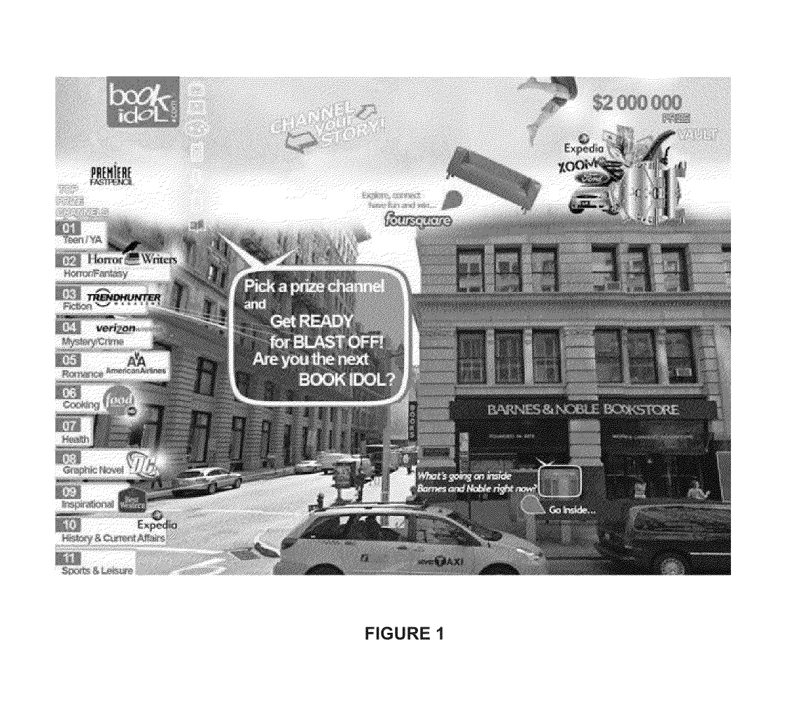

In an embodiment, the background of the landing page (street view) may include a street view of a location near the user based on the geo-location of the user as determined from the user's IP address. In an embodiment, the background view is imported from an external database based on the geo-location of the user. An example is shown in FIG. 1 which illustrates a street view of an intersection of two streets. In an embodiment, the background photo may star one or more sponsors of Book Idol. As shown in FIG. 1, the background photo shows the book store of “Barnes&Noble”.

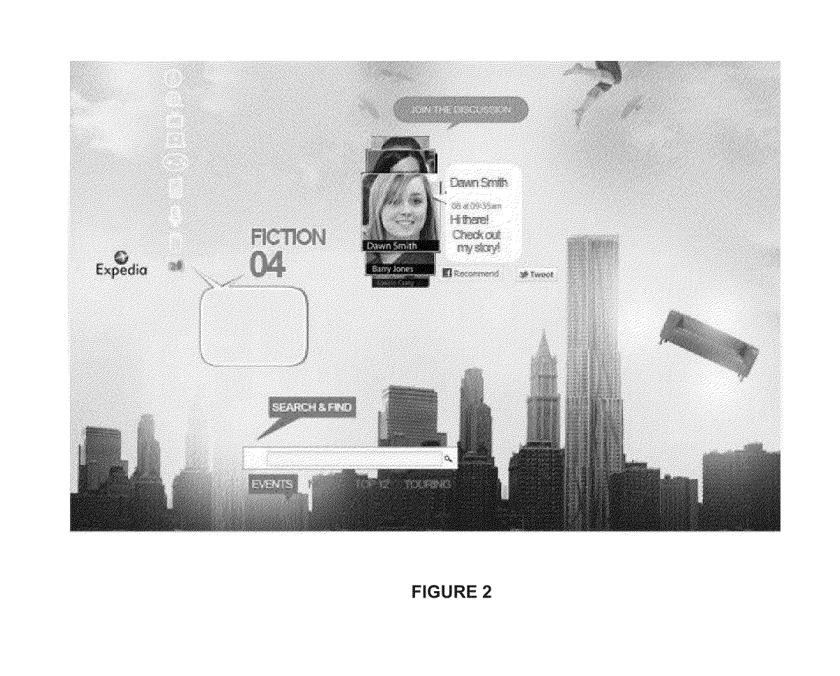

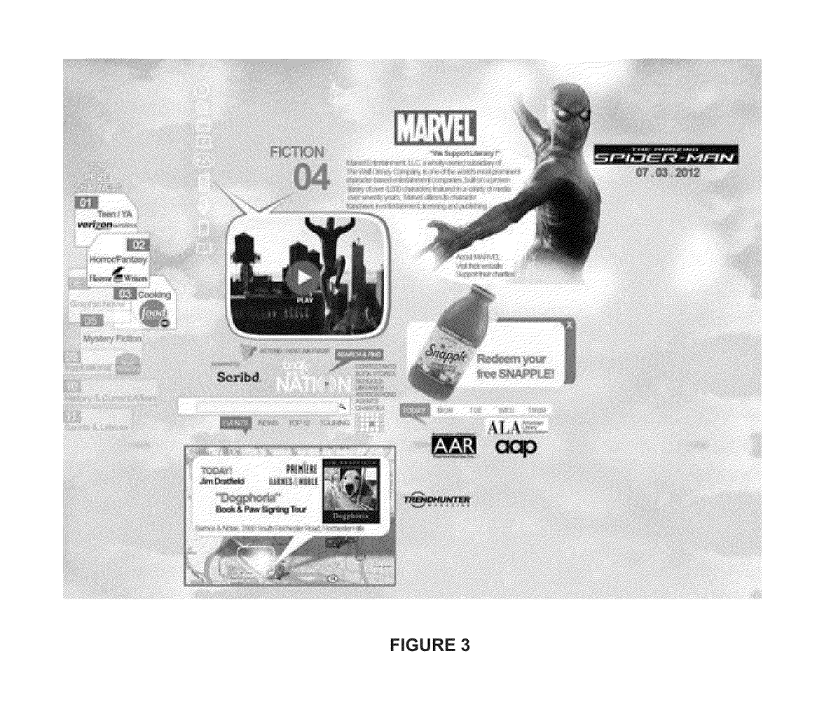

In a non-limiting example of implementation the game is played at three distinct altitudes, from an enhanced “street-view” environment (as a first level) to a “skyline-view” as a second level as exemplified in FIG. 2, to a “prizecloud-view” in the clouds above any given location in any given market as exemplified in FIG. 3.

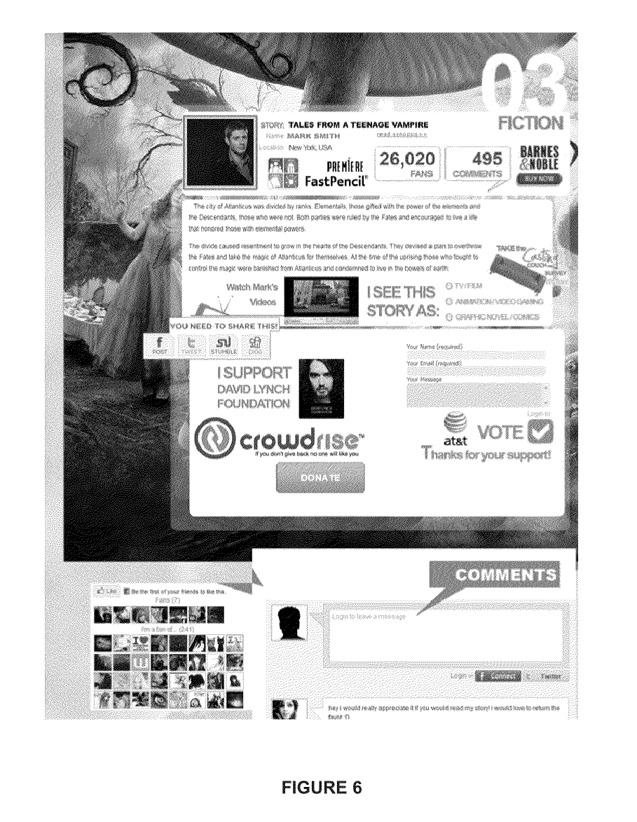

Once on the landing page, the user may choose to “drop in” to default (or customized) landing locations for special events, promotions and rewards. For example, as shown in FIG. 1 the user may choose to drop in at Barnes &Noble to check for promotions or events. The user may also choose to channel their story by setting up an account, and publishing their literature in the showcase page. The showcase page may be used to manage the entire membership database, the contest process and to collect metrics for predictive capabilities of the showcase page. An example of a showcase page is illustrated in FIG. 6.

In an embodiment, the showcase page and its unique functionality features will be displayed as a discreet functional module “floating” in a “cloud environment” above the city/street view as exemplified in the upper part of FIG. 1.

From the street view, the user may choose to blast off to the prizecloud view passing through the skyline view to check out what the local contestants and fans scenes look like as the user rises through the skyline-view.

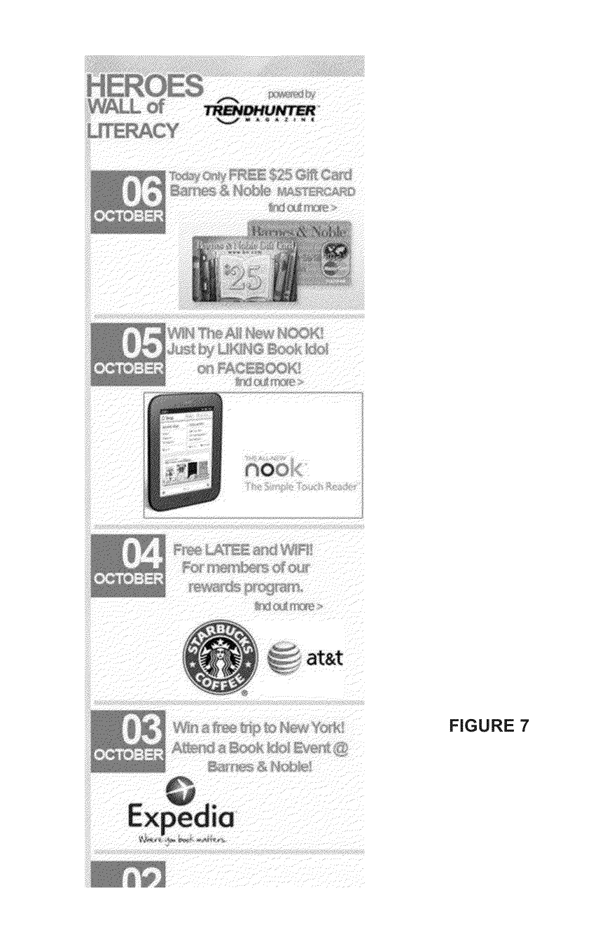

The user may access the Heroes Wall to identify curated products and services and events near them and “go there” to find out more, take advantage of special offers, view or register for special events or spend rewards and virtual currency. An example of a Heroes Wall is illustrated in FIG. 7.

The user may also engage in branded functional modules in the form of micro-games (such as a Fed Ex truck driving by requesting a rewardable action, Spiderman swinging through, etc.) for rewards. These micro-games may be floating in the environment for the user to choose from and engage in.

FIG. 2 illustrates an example of a skyline view in accordance with an embodiment. In an embodiment, the skyline view provides a local view of the user's city/town/region where the user can view local events and promotions happening in their city. The user may also join a discussion with the contestants and/or other users about a book. The discussion may be in the form of a live chat including a written chat, audio chat etc. The discussion may also be static, whereby the user may leave a comment on a wall or under an article etc.

While on skyline view, the user may also view contestants near them and their summary profile/stats and engage in branded functional modules and micro-games for rewards (eg. Airplane fly-through, local weather forecast).

FIG. 3 illustrates an example of a prizecloud view in accordance with an embodiment. In an embodiment the prizecloud may include a background of clouds, as exemplified in FIG. 3. In the prizecloud view the user can use parallax scrolling to “tool around” the Prize Cloud environment, discover rewardable environments, promotional opportunities and criss-cross the map to find new talent, drop-in on sponsors or attend special events. For instance, using parallax scrolling the user may scroll to another city, find talents from other national or international cities etc.

While in skyline view, the user may access access all prize channels and their branded content, all showcase pages, discover, curate, vote, promote, view, get rewards. The user may also engage in branded functional modules, such a “cloud bursting” to discover rewards and new sponsored content.

In an embodiment, the parallax scrolling may be used to explore the virtual environment both vertically and horizontally. Namely, parallax scrolling may be used vertically through the different altitudes to fly through the virtual environment and engage gamified actions at three distinct altitudes, namely street-view skyline-view and prizecloudview. Also, parallax scrolling may also be used horizontally to allow the use to navigate across the country in search for interesting events and local talent, dropping down in on a contestant or Heroe of Literacy, or directionally flying through the clouds and checking for hidden prizes.

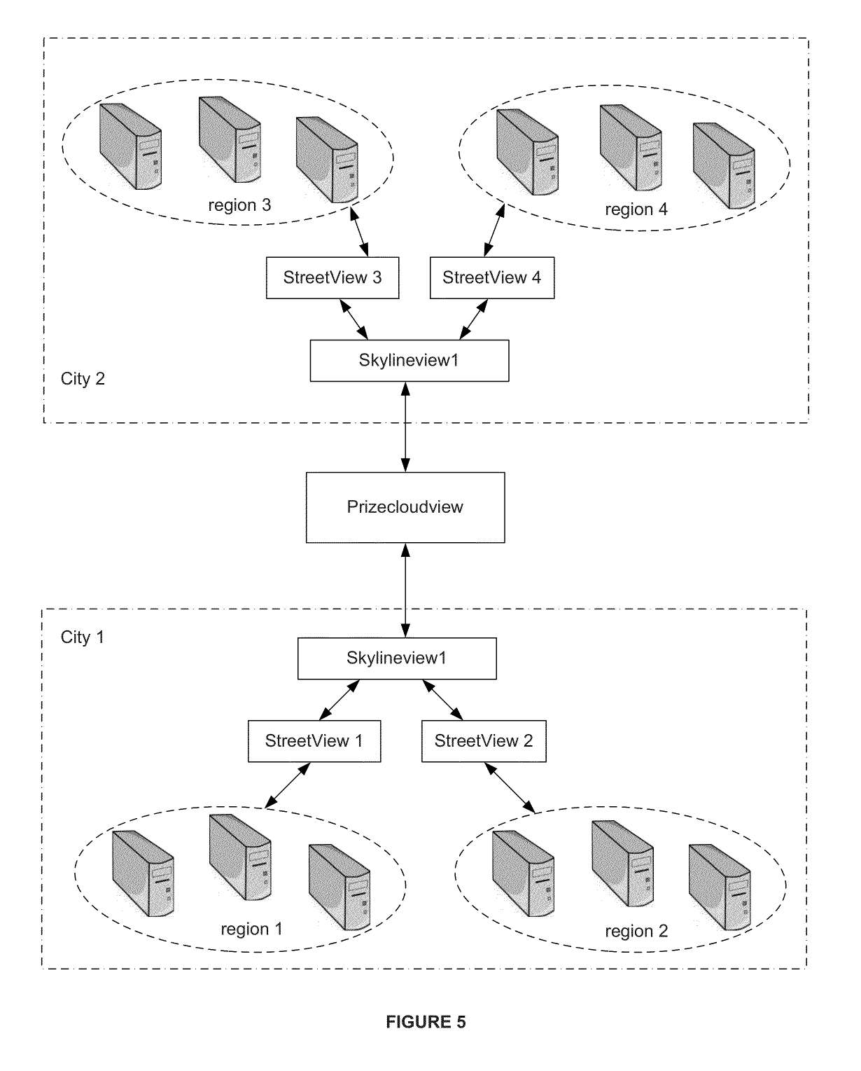

FIG. 5 illustrates an exemplary distribution of access pages based on the geo-location of the users, in accordance with a non-limiting implementation of the present embodiments. The users may be grouped in accordance with their geo-locations as determined from their IP addresses (or other means). As illustrated in FIG. 5, users in region 1 may view streetview page 1, users in region 2 may view streetview page 2, and so on. However, since regions 1 and 2 are both within the same city (city 1), users from these regions may have access to the same skyline view 1 as their default skyline-view page above their default streetview page. The same applies to regions 3 and 4 in city 2.

Users from all regions and all cities may access the same prizecloudview page for reading and voting on scripts by national and international contestants, as illustrated in FIG. 5.

Needless to say, the user may always use parallax scrolling to explore the events in another city and thereby fall on the skyline views of the other cities. However, by providing a unified skyline view image for all users in the same city, and the same streetview image for users in the same neighborhood provides for an improved user experience that is close to reality as the user flies (virtually) vertically and horizontally through the virtual environment. Whereby, the street view and skyline view images become the home image for the user who explores other cities and locations in the virtual environment.

In an embodiment, the icons/links for the prize channels and/or contest levels may be floated on top of the background view as shown for example in FIG. 1, whereby the user may choose the prize channel that they want e.g. romance, and the contest level that they want e.g. movie level or print book level etc. to review and/or watch and/or comment on and/or vote on etc.

Accordingly, the Book idol platform may feature voting, member details, synopsis, sample chapter, e-book, endorsement, promotional and ecommerce capabilities, video uploads, fan tracking, book tour booking, charity endorsements, goods and services promotion, Heroes of Literacy search and find features, celebrity author fan connect, “drop in”, and other complementary capabilities.

### Voting

In an embodiment, voting may only occur in the prizecloud level/view so that users from different locations may participate in the contest. The first level of the contest is at the book level. If successful, the book may evolve to other transmedia types. Accordingly, the book is just the beginning for any blockbuster franchise story that has found its audience. Transmedia storytelling is an industry term used to designate complementary forms of media produced from a single story or storyline which maximally positions stories as branded intellectual properties and their authors as brand creators or “author-preneurs”.

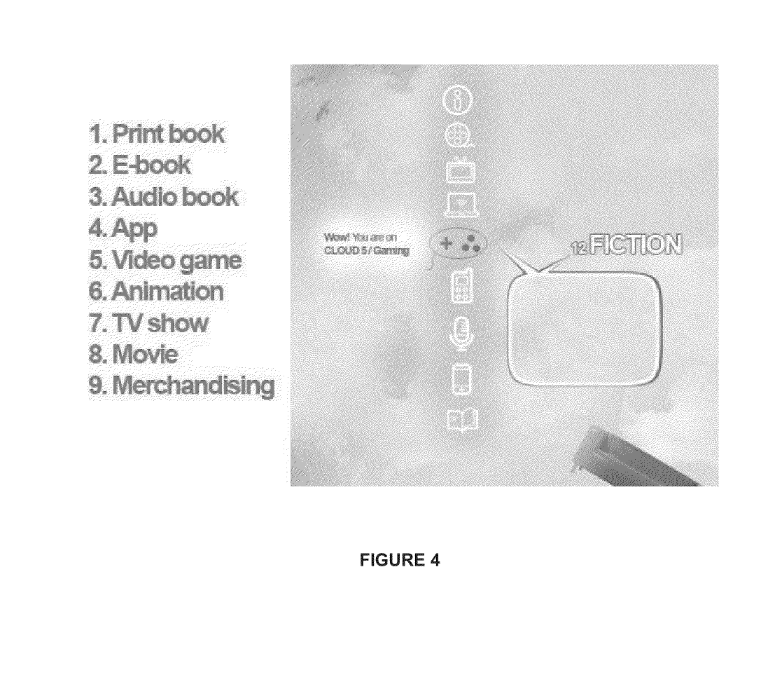

Book Idol strategically extended the voting process and the contest itself to include a series of additional levels to the gaming environment that correspond to existing “transmedia” product categories. FIG. 4 illustrates an example of a list of transmedia product types that the literature may evolve to throughout the gaming process.

In operation, contestants from a certain age and up may register by choosing which genre they will be competing in, and submitting a synopsis and sample chapter for the voting process.

In an embodiment, a first-round voting is done by popularity and will be determined by total number of votes.

The top X number (e.g. top ten) of authors by popular vote may then proceed to “The Gauntlet” in a second round of voting, where a team of celebrity authors and industry professional will validate the quality of the popular vote in round one, either accepting or rejecting submitted works, and provide a detailed critique which the contestants then get to apply over the next 30 days in preparation for the third, and final, round of voting.

Third-round voting resets the vote to zero for each of the top X number of authors in each genre, and the total voting fan-base for each of the genres vote again for a single grand-prize winner for each genre.

Voting for subsequent transmedia categories may follow that same methodology.

Therefore, in order to maximally leverage the licensing potential of Book Idol's discoverability and curation capabilities, winning stories also have a chance to be further packaged by transmedia sponsors in top complementary product categories.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A computer-readable storage device with computer executable instructions stored thereon which, when executed by a processor implement a script based gaming platform for access by one or more users over a communication network (cloud/web), the platform comprising:
a user interface implemented in a web browser and accessible through the communication network;
a virtual environment for accessing and voting on scripts, the virtual environment comprising different pages representing different real views taken from different altitudes, the pages comprising:
a street view page having as background a first image of a real location that is near the geographical location of the user, the street-view page featuring book related events and promotions happening in the user's neighborhood/area;
a skyline-view page having as background a second image featuring a top view of the user's city, the skyline-view page featuring book related events and promotions happening in the user's city;
a prizecloud-view page having as background a third image featuring clouds, the prizecloud view page featuring book related events and promotions happening on a national/international level, and allowing the user to vote on scripts from national and international contestants;
wherein the user may use parallax scrolling to travel vertically through the different pages and horizontally over other cities to explore events and promotions happening in other national/international cities and engage in gamified actions.

2. The device of claim 1, wherein one or more of the first image, second image, and third image are imported from an external website and selected based upon the user's IP address.

3. The device of claim 1, wherein users are grouped based on their IP addresses

4. The device of claim 3, wherein users in the same neighborhood may view the same street-view page.

5. The device of claim 3, wherein users in the same city may view the same skyline-view page.

6. The device of claim 3, wherein all users may view the same prizecloud view page.
